(19) United States
(12) Patent Application Publication
(10) Pub. No.: US 2012/0086616 A1
(43) Pub. Date: Apr. 12, 2012

(54) ANTENNA FOR PROVIDING SELECTIVE RADIATION PATTERNS AND ANTENNA CONSTRUCTION METHOD

(75) Inventors: Ju Derk PARK, Daejeon (KR); Nae Soo KIM, Daejeon (KR); Cheol Sig PYO, Daejeon (KR); Dong Hwa KIM, Seoul (KR); Noh Bok LEE, Seoul (KR)

(73) Assignee: Electronics and Telecommunications Research Institute, Daejeon (KR)

(21) Appl. No.: 13/269,033

(22) Filed: Oct. 7, 2011

(30) Foreign Application Priority Data
Oct. 7, 2010 (KR) 10-2010-0097775
May 20, 2011 (KR) 10-2011-0048098

(51) Int. Cl. H01Q 21/29

(52) U.S. Cl. 343/725

(57) ABSTRACT

An antenna providing a plurality of radiation patterns by adjusting a vertical beamwidth and a construction method for the antenna are provided. The antenna may include an integrated circuit (IC) element unit to provide a plurality of radiation patterns, and a switching unit to selectively provide any one of the plurality of radiation patterns based on control data.

### CROSS-REFERENCE TO RELATED APPLICATIONS

This application claims the benefit of Korean Patent Application No. 10-2010-0097775 and of Korean Patent Application No. 10-2011-0048098, respectively filed on Oct. 7, 2010 and May 20, 2011, in the Korean Intellectual Property Office, the disclosures of which are incorporated herein by reference.

### BACKGROUND

1. Field of the Invention

The present invention relates to a technology for controlling a vertical beam width and a gain of an omni-directional antenna attached to sensor nodes forming a sensor network.

2. Description of the Related Art

In general, sensor nodes forming a sensor network use an omni-directional antenna for communication. The omni-directional antenna has fixed radiation characteristics of radio waves and therefore has a uniform horizontal beamwidth.

In particular, as a distance between two sensor nodes to communicate becomes shorter, a wider horizontal beamwidth is demanded. Also, as a distance between two sensors becomes longer, a narrower vertical beamwidth with a larger gain is demanded. Therefore, conventional sensor nodes use a multi port and an array-type omni-directional antenna to perform near field communication (NFC) and far field communication (FFC).

However, use of the multi port and the array-type omni-directional antenna usually increases sizes of the sensor nodes and also increases power consumption.

Accordingly, there is a desire for a new secure scheme to provide near field communication (NFC) and far field communication (FFC) using a single port omni-directional antenna.

### SUMMARY

An aspect of the present invention provides a technology for providing near field communication (NFC) and far field communication (FFC) by selectively using a vertical beamwidth through a single port omni-directional antenna.

Another aspect of the present invention provides a technology for minimizing a size of a terminal using a single port omni-directional antenna.

Still another aspect of the present invention provides a technology for reducing power consumption of a terminal by providing inter-terminal communication using an omni-directional antenna including a passive element.

According to an aspect of the present invention, there is provided an antenna including an integrated circuit (IC) element unit to provide a plurality of radiation patterns; and a switching unit to selectively provide any one of the plurality of radiation patterns.

The switching unit may selectively provide any one of the plurality of radiation patterns, based on control data generated according to an operation mode of a terminal.

The IC element unit may include an impedance matching circuit unit to form a first radiation pattern corresponding to a far field communication (FFC) mode; and a transmission line unit to form a second radiation pattern corresponding to a near field communication (NFC) mode.

The switching unit may selectively provide any one of the first radiation pattern and the second radiation pattern, based on a first signal strength received using the first radiation pattern and a second signal strength received using the second radiation pattern.

The IC element unit may add an operation mode of a terminal by further forming a third radiation pattern differentiated from the first radiation pattern and the second radiation pattern.

According to another aspect of the present invention, there is provided an antenna construction method including providing a plurality of radiation patterns; and selectively providing any one of the plurality of radiation patterns based on control data.

The providing of the plurality of radiation patterns may include forming a first radiation pattern corresponding to a far field communication (FFC) mode; and forming a second radiation pattern corresponding to a near field communication (NFC) mode.

The providing of the plurality of radiation patterns may include adding an operation mode of a terminal by further forming a third radiation pattern differentiated from the first radiation pattern and the second radiation pattern.

### EFFECT

According to embodiments of the present invention, near field communication (NFC) and far field communication (FFC) may be provided by selectively using a vertical beamwidth through a single port omni-directional antenna.

Additionally, according to embodiments of the present invention, a terminal size may be minimized using a single port omni-directional antenna.

Additionally, according to embodiments of the present invention, power consumption of a terminal may be reduced since inter-terminal communication is provided using an omni-directional antenna including a passive element.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a structure of an entire sensor network system according to an embodiment of the present invention;

FIG. 2 is a block diagram illustrating a detailed structure of an antenna according to an embodiment of the present invention;

FIG. 3 is a diagram illustrating a radiation pattern formed when near field communication (NFC) is performed among terminals, according to an embodiment of the present invention;

FIG. 4 is a diagram illustrating a radiation pattern formed when far field communication (FFC) is performed among terminals, according to an embodiment of the present invention;

FIG. 5 is a diagram illustrating a structure of a single port directional antenna according to an embodiment of the present invention;

FIG. 6 is a diagram illustrating a radiation pattern formed when NFC is performed by an antenna according to an embodiment of the present invention;

FIG. 7 is a diagram illustrating a radiation pattern formed when FFC is performed by an antenna according to an embodiment of the present invention; and

FIG. 8 is a flowchart illustrating an antenna construction method according to an embodiment of the present invention.

### DETAILED DESCRIPTION

Reference will now be made in detail to exemplary embodiments of the present invention, examples of which are illustrated in the accompanying drawings. While specific terms were used, they were not used to limit the meaning or the scope of the present invention described in claims. Therefore, the terms are to be interpreted corresponding to the technical concept of the present invention, based on that the inventor is capable of properly define the terms to explain the present invention in the best manner.

Accordingly, embodiments and structures illustrated herein are suggested only by way of example but do not represent all technical concepts of the present invention. Therefore, it will be understood that various equivalents and modifications may exist which can replace the embodiments described in the time of the application. In addition, like reference numerals refer to the like elements throughout the drawings.

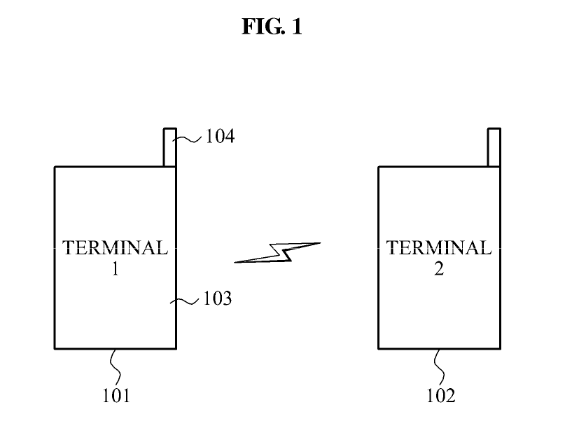

FIG. 1 is a diagram illustrating a structure of an entire sensor network system according to an embodiment of the present invention.

According to FIG. 1, a first terminal 101 and a second terminal 102 form a network. The first terminal may include a body 103 and an antenna 104. The body 103 refers to a portion of the first terminal 101 excluding the antenna 104. The body 103 may include various modules and elements necessary for communication. A single port omni-directional antenna may be used as the antenna 104. Thus, when a single antenna is employed, rather than multi antennas a size of the first terminal 101 may be minimized. Here, the first terminal 101 may include a portable device such as a sensor node and a radiotelegraph. Therefore, each sensor node may form a sensor network such as an ad-hoc network. Additionally, the single port omni-directional antenna may be attached to each sensor node. Therefore, the omni-directional antenna may selectively use a vertical beamwidth according to a distance between the sensor nodes.

As an example, when near field communication (NFC), that is where a distance between a first sensor node and a second sensor node is short is performed, the antennas attached to the respective sensor nodes may form a radiation pattern having a wide vertical beamwidth.

As another example, when far field communication (FFC), that is, where a distance between the first sensor node and the second sensor node is long is performed, the antennas attached to the respective sensor nodes may increase a gain and form a radiation pattern having a narrow vertical beamwidth.

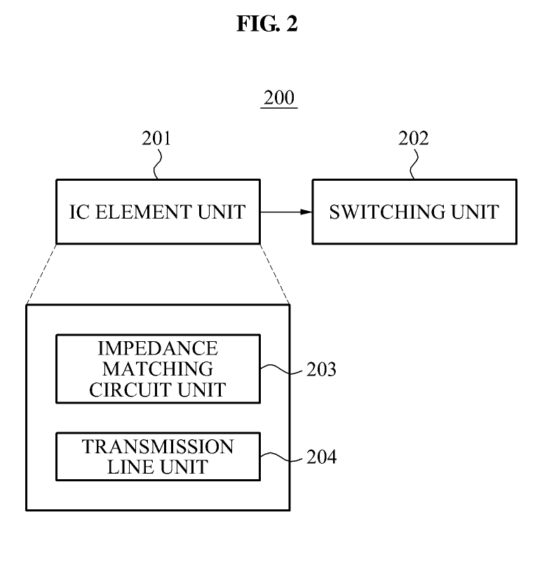

FIG. 2 is a block diagram illustrating a detailed structure of an antenna according to an embodiment of the present invention.

According to FIG. 2, an antenna 200 may include an integrated circuit (IC) element unit 201 and a switching unit 202. Here, the antenna 200 may be a single port directional antenna and include passive elements.

First, the IC element unit 201 may provide a plurality of radiation patterns. For example, the IC element unit 201 may provide a radiation pattern having a wide vertical beamwidth, a radiation pattern having a narrow vertical beamwidth, and the like. Here, the IC element unit 201 may include an impedance matching circuit unit 203 and a transmission line unit 204.

The impedance matching circuit unit 203 may form a first radiation pattern corresponding to an FFC mode. For example, the impedance matching circuit unit 203 may include an inductor (L) and a capacitor (C). Here, the FFC mode refers to an operation mode where a distance between a terminal attached with the antenna 200 and a neighboring terminal is not less than a preset reference value and therefore the terminal and the neighboring terminal may perform long distance communication. That is, in the FFC mode, the distance between the terminal and the neighboring terminal is long.

More specifically, the impedance matching circuit unit 203 may match an impedance of the antenna 200 by adjusting impedances of radio waves. That is, the impedance matching circuit unit 203 may form the first radiation pattern corresponding to a short dipole antenna through the impedance matching. When the first radiation pattern corresponding to the short dipole antenna is formed thusly, the terminal attached with the antenna 200 may perform FFC with the neighboring terminal.

The transmission line unit 204 may form a second radiation pattern corresponding to a monopole antenna by bypassing radio waves. When the second radiation pattern corresponding to the monopole antenna is formed, the terminal attached with the antenna 200 may perform NFC with the neighboring terminal. Here, the NFC refers to a state where a distance between the terminal and the neighboring terminal is less than the preset reference value.

The switching unit 202 may selectively provide any one of a plurality of radiation patterns formed by the IC element unit 201. The switching unit 202 may be switched to the impedance matching circuit unit 203 or the transmission line unit 204 based on control data input from a body of the terminal.

For example, the switching unit 202 may be selectively switched to any one of the plurality of radiation patterns based on the control data generated according to an operation mode. The operation mode may contain information indicating whether the terminal is in the NFC mode performing NFC with the neighboring terminal or in the FFC mode performing FFC with the neighboring terminal. When the control data indicates that the operation mode of the terminal is the FFC mode, the switching unit 202 may be connected with the impedance matching circuit unit 203 by switching. When the control data indicates that the operation mode of the terminal is the NFC mode, the switching unit 202 may be connected with the transmission line unit 204 by switching.

As another example, the switching unit 202 may be selectively switched to any one of the plurality of radiation patterns based on strength of a signal received from the neighboring terminal, using the respective radiation patterns. Specifically, a microcomputer as a component of the body of the terminal may measure a first strength of the signal received from the neighboring terminal, through the first radiation pattern formed by the impedance matching circuit unit 203. Also, the microcomputer may measure a second strength of the signal received from the neighboring terminal, through the second radiation pattern formed by the transmission line unit 204. A received signal strength indicator (RSSI) may be used to measure the strength of the signal. In addition, the microcomputer may use a link quality indicator (LQI) to generate the control data indicating one of the first radiation pattern and the second radiation pattern.

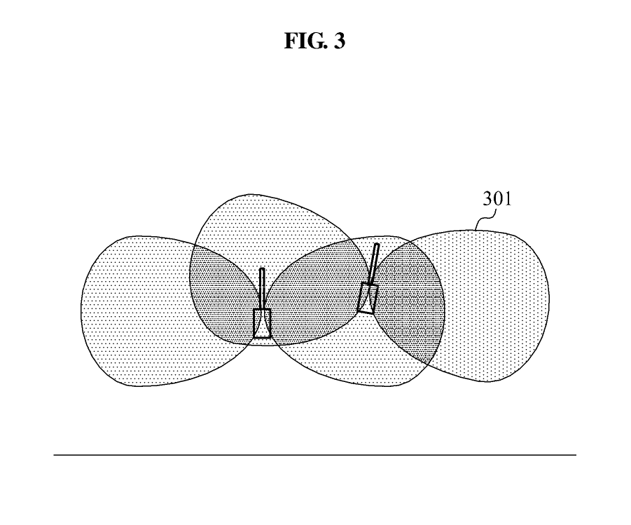

FIG. 3 is a diagram illustrating a radiation pattern formed when NFC is performed among terminals, according to an embodiment of the present invention.

According to FIG. 3, when a distance between respective two terminals forming the sensor network is short, that is, less than a preset reference value, antennas attached to the respective terminals may operate as monopole antennas by bypassing radio waves by a transmission line unit. Accordingly, when NFC is performed, the antennas may form radiation patterns 301 having a wide vertical beamwidth.

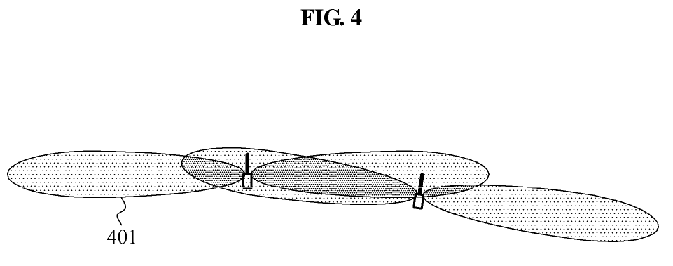

FIG. 4 is a diagram illustrating a radiation pattern formed when FFC is performed among terminals, according to an embodiment of the present invention.

According to FIG. 4, when a distance between two respective terminals is long, that is, not less than a preset reference value, antennas attached to the respective terminals may operate as short dipole antennas by impedance matching. Accordingly, when FFC is performed, the antennas may obtain a large gain and form radiation patterns 401 having a narrow vertical beamwidth.

As described in the foregoing with reference to FIGS. 3 and 4, the single port directional antenna may provide both NFC and FFC by impedance matching or bypassing.

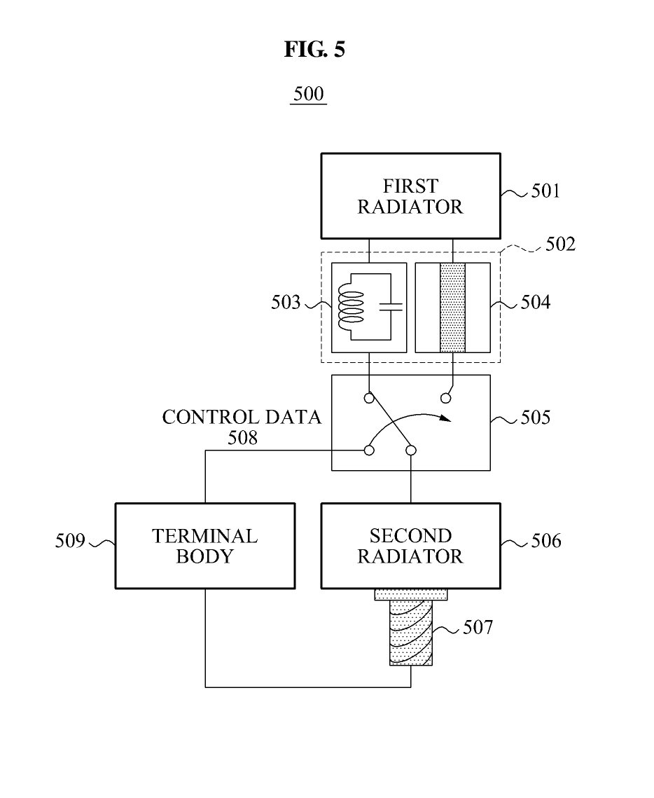

FIG. 5 is a diagram illustrating a structure of a single port directional antenna according to an embodiment of the present invention.

According to FIG. 5, the single port directional antenna 500 includes a first radiator 501, an IC element unit 502, a switching unit 505, a second radiator 506, and an RF contactor 507. The IC element unit 502 may include an impedance matching circuit unit 503 including an inductor (L) and a capacitor (C), and a transmission line unit 504. The single port directional antenna 500 may include passive elements. Since the operation of the IC element unit 502 and the switching unit 505 of FIG. 5 are the same as the operation of the IC element unit 201 and the switching unit 202 of FIG. 2, a detailed description thereof will be omitted for conciseness.

First, the first radiator 501 may radiate radio waves according to a radiation pattern selected by switching from a plurality of radiation patterns. Here, the first radiator 501 may be connected to the IC element unit 502.

Similarly, the second radiator 506 may radiate radio waves according to a radiation pattern selected by switching from the plurality of radiation patterns. The second radiator 506 is disposed to face the first radiator 502. One end of the second radiator 506 is connected to the switching unit 505 while the other end is connected to the RF contactor 507.

The impedance matching circuit unit 503 may operate the single port directional antenna 500 as a short dipole antenna by impedance matching. That is, the impedance matching circuit unit 503 may form a radiation pattern corresponding to the short dipole antenna.

The transmission line unit 504 may operate the single port directional antenna 500 as a monopole antenna by bypassing the radio waves. That is, the transmission line unit 504 may form a radiation pattern corresponding to the monopole antenna.

The switching unit 505 may be switched to the IC element unit 503 or the transmission line unit 504 based on control data 508 input from a body 509 of a terminal. Here, the control data may indicate whether the switching unit 505 is switched to the IC element unit 503 or the transmission line unit 504. Thus, the switching unit 505 may connect the second radiator 506 with the IC element unit 503 or the transmission line unit 504 by switching.

The RF contactor 507 is connected to the body 509 of the terminal, and transmits a signal received from the body 509 to the second radiator 506. For example, one end of the RF contactor 507 may be connected to the second radiator 506 while the other end is connected to the body 509.

Although the impedance matching circuit units of FIGS. 2 and 5 are described as the LC circuit, the impedance matching circuit units may be a resistor, inductor, and capacitor (RLC) circuit.

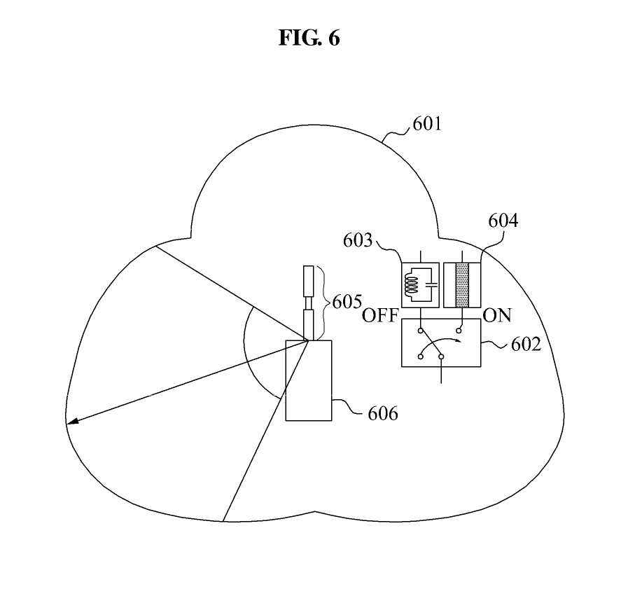

FIG. 6 is a diagram illustrating a radiation pattern formed when NFC is performed by an antenna 605 according to an embodiment of the present invention.

According to FIG. 6, in the NFC mode, the switching unit 602 may be switched to a transmission line unit 604 between an impedance matching circuit unit 603 and the transmission line unit 604. Therefore, the antenna 605 may operate as a monopole antenna. That is, the antenna 605 may form a radiation pattern 601 expanding toward a body 606 of a terminal more than toward the antenna 605.

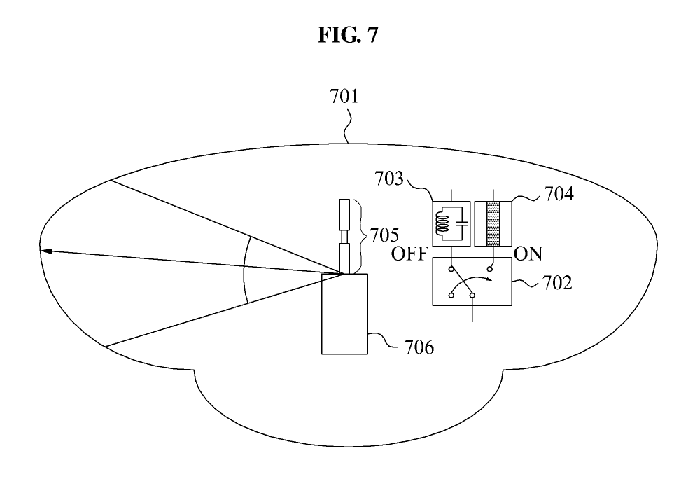

FIG. 7 is a diagram illustrating a radiation pattern formed when FFC is performed by an antenna according to an embodiment of the present invention.

According to FIG. 7, in the FFC mode, a switching unit 702 may be switched to an impedance matching circuit unit 703 between the impedance matching circuit unit 703 and a transmission line unit 704. Therefore, an antenna 705 may operate as a short dipole antenna. That is, the antenna 705 may form a radiation pattern 701 expanding to the antenna 705 more than to a body 706 of a terminal.

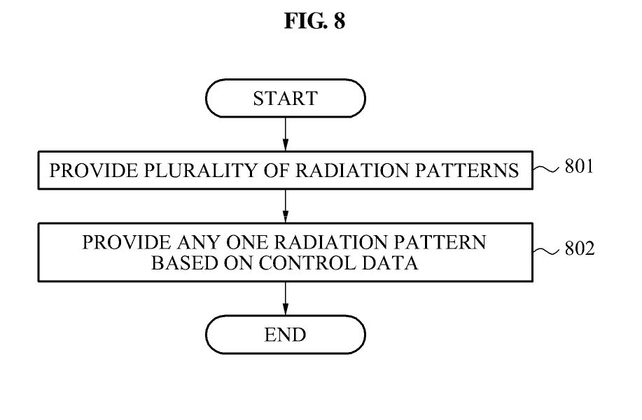

FIG. 8 is a flowchart illustrating an antenna construction method according to an embodiment of the present invention.

According to FIG. 8, in operation 801, an antenna may provide a plurality of radiation patterns. Here, the antenna may be a single port directional antenna.

For example, the antenna may form a first radiation pattern corresponding to a FFC mode through impedance matching. In addition, the antenna may form a second radiation pattern corresponding to a NFC mode by bypassing radio waves. That is, the antenna may selectively provide a proper radiation pattern based on a distance between a terminal attached with the antenna and a neighboring terminal. As a result, both NFC and FFC may be provided by one antenna.

In operation 802, the antenna may selectively provide any one of the plurality of radiation patterns based on control data input from a body of the terminal.

More specifically, the antenna may be switched to the first radiation pattern corresponding to the FFC mode or to the second radiation pattern corresponding to the NFC mode, based on the control data.

For example, the control data may be generated based on a first signal strength received using the first radiation pattern and a second signal strength received using the second radiation pattern. For example, when the antenna operates as a short dipole antenna, a microcomputer may measure a first strength of the signal received from the neighboring terminal, using a radiation pattern corresponding to the short dipole antenna. Also, the antenna may operate as a monopole antenna by switching. The microcomputer may measure a second strength of the signal received from the neighboring terminal, using a radiation pattern corresponding to the monopole antenna. The microcomputer may compare the first signal strength and the second signal strength, thereby selecting a more appropriate strength. Next, the microcomputer may generate the control data indicating components to form the radiation pattern corresponding to the selected signal strength. Therefore, the antenna may form the radiation pattern proper for communication with the neighboring terminal, by switching based on the control data.

When the first signal strength and the second signal strength are similar, the microcomputer may select one of the first signal strength and the second signal strength, which allows for lower power consumption. When the first signal strength and the second signal strength are similar and power consumption levels are also similar, the microcomputer may generate the control data to form the second radiation pattern for bypassing radio waves.

As another example, when the operation mode of the terminal is known through the microcomputer, the microcomputer may generate the control data based on the operation mode of the terminal. Specifically, when the operation mode is the FFC mode, the microcomputer may generate the control data to form the radiation pattern through impedance matching. When the operation mode is the NFC mode, the microcomputer may generate the control data to form the radiation pattern through bypassing. Accordingly, the antenna may be switched based on the control data and form the radiation pattern corresponding to the operation mode of the terminal.

The operation mode of the terminal has been described to include the FFC mode and the NFC mode. However, the terminal may include at least three operation modes. In this case, the antenna may add the operation mode by additionally including an impedance matching circuit unit to form a particular radiation pattern. For example, when the antenna 200 of FIG. 2 further includes the impedance matching circuit unit, the operation mode may be classified into a short distance communication mode, a medium distance communication mode, and a long distance communication mode. Similarly, when two impedance matching circuit units are added to the antenna 200 of FIG. 2, the IC element unit may classify the operation mode of the terminal into four modes.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An antenna comprising:
an integrated circuit (IC) element unit to provide a plurality of radiation patterns; and
a switching unit to selectively provide any one of the plurality of radiation patterns.

2. The antenna of claim 1, wherein the antenna is a single port directional antenna.

3. The antenna of claim 1, wherein the switching unit selectively provides any one of the plurality of radiation patterns, based on control data generated according to an operation mode of a terminal.

4. The antenna of claim 1, wherein the IC element unit comprises:
an impedance matching circuit unit to form a first radiation pattern corresponding to a far field communication (FFC) mode; and
a transmission line unit to form a second radiation pattern corresponding to a near field communication (NFC) mode.

5. The antenna of claim 4, wherein the switching unit selectively provides any one of the first radiation pattern and the second radiation pattern, based on a first signal strength received using the first radiation pattern and a second signal strength received using the second radiation pattern.

6. The antenna of claim 4, wherein the IC element unit adds an operation mode of a terminal by further forming a third radiation pattern differentiated from the first radiation pattern and the second radiation pattern.

7. The antenna of claim 1, further comprising:
a first radiator to radiate radio waves according to a selected one of the plurality of radiation patterns; and
a second radiator disposed to face the first radiator to radiate radio waves according to the selected radiation pattern.

8. The antenna of claim 7, wherein
the first radiator is connected to the IC element unit, and
one end of the second radiator is connected to the switching unit and the other end of the second radiator is connected to a radio frequency (RF) contactor.

9. The antenna of claim 8, wherein the RF contactor is connected to a body of a terminal.

10. The antenna of claim 1, wherein the IC element unit provides a radiation pattern corresponding to a short dipole antenna.

11. The antenna of claim 1, wherein the IC element unit provides a radiation pattern corresponding to a monopole antenna.

12. The antenna of claim 1, wherein the IC element unit is a passive element.

13. An antenna construction method comprising:
providing a plurality of radiation patterns; and
selectively providing any one of the plurality of radiation patterns based on control data.

14. The antenna construction method of claim 13, wherein the selective providing of the radiation pattern comprises:
selectively providing any one of the plurality of radiation patterns based on the control data generated according to an operation mode of a terminal.

15. The antenna construction method of claim 13, wherein the providing of the plurality of radiation patterns comprises:
forming a first radiation pattern corresponding to a far field communication (FFC) mode; and
forming a second radiation pattern corresponding to a near field communication (NFC) mode.

16. The antenna construction method of claim 15, wherein
the control data is generated based on a first signal strength received using the first radiation pattern and a second signal strength received using the second radiation pattern, and
the selective providing of the radiation pattern comprises selectively providing any one of the first radiation pattern and the second radiation pattern based on the generated control data.

17. The antenna construction method of claim 15, wherein the providing of the plurality of radiation patterns comprises:
adding an operation mode of a terminal by further forming a third radiation pattern differentiated from the first radiation pattern and the second radiation pattern.

18. The antenna construction method of claim 13, wherein the providing of the plurality of radiation patterns comprises:
providing a radiation pattern corresponding to a short dipole antenna among the plurality of radiation patterns.

19. The antenna construction method of claim 13, wherein the providing of the plurality of radiation patterns comprises:
providing a radiation pattern corresponding to a monopole antenna among the plurality of radiation patterns.

20. The antenna construction method of claim 13, wherein the providing of the plurality of radiation patterns comprises:
providing the plurality of radiation patterns using a passive element.
